(19) United States
(12) Patent Application Publication
(10) Pub. No.: US 2013/0015598 A1
(43) Pub. Date: Jan. 17, 2013

(54) IMPRINT APPARATUS AND ARTICLE MANUFACTURING METHOD

(71) Applicant: Atsushi KIMURA, Saitama-shi (JP)

(72) Inventor: Atsushi KIMURA, Saitama-shi (JP)

(73) Assignee: CANON KABUSHIKI KAISHA, Tokyo (JP)

(21) Appl. No.: 13/545,483

(22) Filed: Jul. 10, 2012

(30) Foreign Application Priority Data
Jul. 12, 2011 (JP) 2011-153737

(51) Int. Cl. B29C 59/02

(52) U.S. Cl. 264/40.1; 425/150

(57) ABSTRACT

The imprint apparatus of the present invention includes a controller that has a first servo controller configured to servo-control a first drive unit; a second servo controller configured to servo-control a second drive unit; and a correction controller configured to execute calculation processing for calculating a correction value for correcting a force, which is applied to a mold or a substrate when the mold is brought into contact with the substrate via an imprint material, based on a relative position between a mold holding unit and a substrate holding unit in a contact direction and correct at least one of command values to be transmitted to the first or second drive unit by the first or second servo controller based on the correction value.

### BACKGROUND OF THE INVENTION

1. Field of the Invention

The present invention relates to an imprint apparatus and an article manufacturing method using the same.

2. Description of the Related Art

As the demand for microfabrication of semiconductor devices increases, not only a conventional photolithography technology but also a microfabrication technology in which an uncured resin on a substrate is molded by a mold to thereby form a resin pattern on the substrate have been receiving attention. This technology is also referred to as an “imprint technology”, by which a fine structure with dimensions of a few nanometers can be formed on a substrate. One example of imprint technologies includes a photo-curing method. An imprint apparatus employing the photo-curing method first applies an ultraviolet curable resin (imprint material, photocurable resin) to a shot area (imprint area) on a substrate (wafer). Next, the resin (uncured resin) is molded by a mold. After the ultraviolet curable resin is irradiated with ultraviolet light for curing, the cured resin is released from the mold, whereby a resin pattern is formed on the substrate.

U.S. Pat. No. 7,281,921 discloses an imprint apparatus including an imprint head that holds a mold and drives the mold in a pressing direction (contact direction), a substrate stage that holds a substrate, and a measurement system that measures the positions of the imprint head and the substrate stage, all of which are mounted on an integrated base frame. In particular, in the imprint apparatus, a drive mechanism that presses a mold against a resin applied on a substrate or releases the mold from the resin is installed in the imprint head as described above or is installed in the substrate stage. In this case, the contact orientation of either one of the substrate stage or the imprint head which is not driven is maintained against a pressing force or a releasing force due to the rigidity of the structure thereof.

However, in the imprint apparatus, either one of the substrate stage or the imprint head which is not driven cannot act against the pressing force or the releasing force but only receives the pressing force or the releasing force. Hence, an accurate contact position is difficult to be held. In addition, for example, the film thickness of the resin may vary upon contacting due to variations in the contact direction of the substrate side or the mold side, whereas the pattern formed on the resin may be fallen down upon releasing due to the shake of the mold in the tilt direction.

On the other hand, for a substrate on which a pattern has been formed by an imprint apparatus, a series of processing steps is repeated in which the subsequent manufacturing steps such as an etching step and an oxidizing step are carried out so as to proceed to a pattern-forming step again. Thus, in order to accurately superpose a pattern image in manufacturing steps, positioning of the same substrate must be performed for each step. An example of such a positioning method includes an advanced global alignment method (AGA) using an off-axis alignment scope. In the alignment method, prior to pattern formation, a substrate placed on a substrate stage which is excellent in positioning accuracy in the X and Y directions (horizontal direction) is firstly moved in the X and Y directions with respect to the off-axis alignment scope and the X-Y positional array state for a pattern group on the substrate is read. At this time, a target for measurement is not the entire shots but may be some representative points. Next, the stage coordinate positions of all of the shots are estimated based on the read array state. Thereafter, while keeping the stage accuracy in trust until the substrate is replaced with the next substrate, a pattern is formed for all of the shots on the substrate without reading the amount of misalignment.

However, it may be disadvantageous to employ AGA as it is for the imprint apparatus in which either one of the substrate stage or the imprint head is not driven when the mold is brought into contact with the resin on the substrate. Firstly, since the weight of the substrate stage is typically heavy, its moving load may induce deformation of the base frame mounting the measurement system. Thus, a difference from pre-obtained alignment information about the substrate may arise, resulting in the occurrence of alignment error. In order to handle this shortcoming, an integrated base frame may be separated into a stage surface plate and a measurement surface plate. For example, the stage is installed on the stage surface plate fixed on a floor and the imprint head and the measurement system are installed on the measurement surface plate which is supported by a supporting leg(s) having a certain height, which is/are installed on the floor, via a vibration-isolating mount. However, when the contact direction and the tilt direction for the substrate stage are fixed, the relative distance between the measurement surface plate and the imprint head fixed on the measurement surface plate changes due to the deviation of the mount. Consequently, it becomes difficult to maintain the contact orientation and the gap during an alignment operation.

### SUMMARY OF THE INVENTION

Accordingly, the present invention provides an imprint apparatus that is advantageous for holding the contact position at which a mold is in contact with a resin on a substrate and for improving positioning accuracy.

According to an aspect of the present invention, an imprint apparatus that brings an imprint material on a substrate into contact with a mold to thereby transfer a pattern formed on the mold onto the substrate is provided that includes a mold holding unit configured to hold the mold; a substrate holding unit configured to hold the substrate; first and second drive units configured to drive the mold holding unit and the substrate holding unit, respectively, in a contact direction; first and second position sensors configured to detect the positions of the mold holding unit and the substrate holding unit, respectively, in the contact direction; and a controller configured to control the first and second drive units, wherein the controller includes a first servo controller configured to servo-control the first drive unit based on the position detected by the first position sensor and a first target value; a second servo controller configured to servo-control the second drive unit based on the position detected by the second position sensor and a second target value; and a correction controller configured to execute calculation processing for calculating a correction value for correcting a force, which is applied to the mold or the substrate when the mold is brought into contact with the substrate via the imprint material, based on the relative position between the mold holding unit and the substrate holding unit in the contact direction and correct at least one of command values to be transmitted to the first or second drive unit by the first or second servo controller based on the correction value.

Further features of the present invention will become apparent from the following description of exemplary embodiments with reference to the attached drawings.

### BRIEF DESCRIPTION OF THE DRAWINGS

FIG. 1 is a diagram illustrating the configuration of an imprint apparatus according to one embodiment of the present invention.

FIG. 2 is a block diagram illustrating a stabilization control system including a position control loop.

FIG. 3 is a block diagram illustrating another stabilization control system including a position control loop.

FIG. 4 is a flowchart illustrating the flow of the imprint processing steps.

FIG. 5 is a block diagram illustrating a first example of a control system for deriving a Z-force.

FIG. 6 is a block diagram illustrating a second example of a control system for deriving a Z-force.

FIG. 7 is a graph illustrating the Z position of an imprint head and the Z-force applied thereby.

### DESCRIPTION OF THE EMBODIMENTS

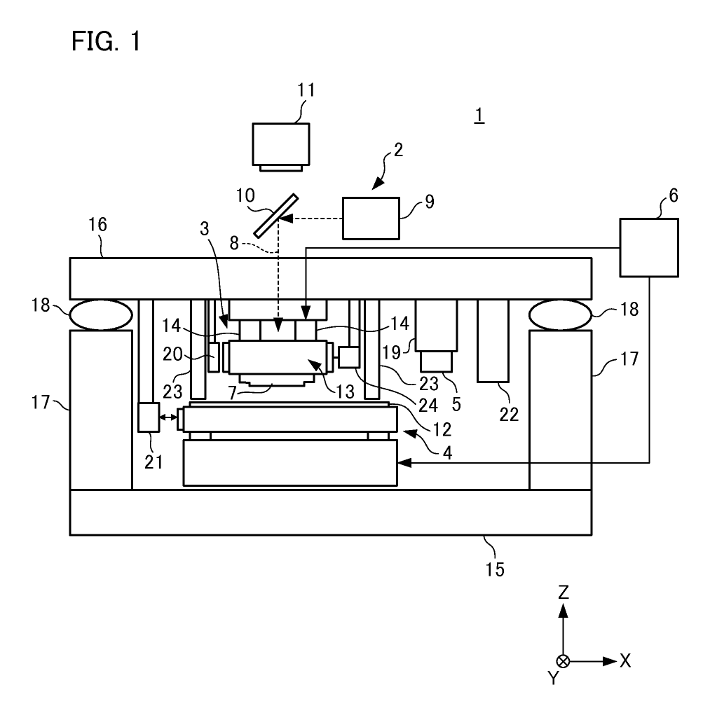

Firstly, a description will be given of the configuration of an imprint apparatus according to one embodiment of the present invention. FIG. 1 is a diagram illustrating the configuration of an imprint apparatus of the present embodiment. The imprint apparatus is an apparatus that molds an imprint material (typically, uncured resin) on a wafer (on a substrate), i.e., an object to be treated, using a mold to thereby form a pattern (typically, resin pattern) on the substrate, which is used in the manufacture of devices such as semiconductor devices and the like. Here, the imprint apparatus of the present embodiment is an apparatus employing a photo-curing method. In the following drawings, a description will be given where the Z axis is aligned parallel to the optical axis of each irradiation unit that irradiates ultraviolet light onto a resin on a substrate, and mutually orthogonal axes X and Y are aligned in the direction in a plane perpendicular to the Z axis. Firstly, an imprint apparatus 1 includes a light irradiation unit 2, a mold holding mechanism 3, a wafer stage 4, a dispenser 5, and a controller 6.

The light irradiation unit 2 irradiates a mold 7 with an ultraviolet light 8 during imprint processing. The light irradiation unit 2 includes a light source 9 and a half mirror 10 that reflects the ultraviolet light 8 emitted from the light source 9 toward the mold 7. The light irradiation unit 2 may also include a plurality of optical elements (not shown) that adjusts the ultraviolet light 8 emitted from the light source 9 to light suitable for imprint, a shutter (not shown) that adjusts irradiation or non-irradiation of the ultraviolet light 8, and the like. Here, as a light source, a high-pressure mercury lamp, various excimer lamps, an excimer laser, a light emitting diode, or the like may be employed. Although the light source is appropriately selected in accordance with the characteristics of a resin which is a light-receiving body, the present invention is not limited by the type, number, and wavelength of light sources. In the imprint apparatus 1, a photographing device 11 may also be installed above the half mirror 10 as shown in FIG. 1 in order to appropriately confirm the state of the mold 7. Also, the mold 7 has a predetermined pattern (e.g., a concave and convex pattern such as a circuit pattern or the like) that is three-dimensionally formed on a surface facing a wafer 12. The material of the mold 7 is a material such as quartz or the like through which ultraviolet light can pass.

The mold holding mechanism 3 draws and holds the mold 7 using a vacuum attraction force or an electrostatic force. The mold holding mechanism 3 includes an imprint head (mold holding unit) 13 including a mold chuck which directly holds the mold 7. Also, the mold holding mechanism 3 includes a mold drive mechanism (first drive unit) 14 that drives the imprint head 13 in the Z axial direction so as to press the mold 7 against an ultraviolet curable resin applied to the wafer 12. The mold drive mechanism 14 consists of at least three or more motors so as to be able to impart a thrust in the Z axial direction and a torque in the rotating direction of the θx-axis and the θy-axis about the X axis and the Y axis, respectively. The mold drive mechanism 14 is capable of controlling the position of the mold 7 in the XYZ axial direction. Furthermore, the imprint head 13 includes a deformation mechanism (not shown) that deforms the mold 7 into a convex shape toward the contact direction with the resin on the wafer 12. The deformation mechanism is, for example, an air compression system that imparts a positive pressure to the light-irradiating face side of the mold 7. Here, the imprint head 13 (mold chuck) has a hollow bore at the central part of the X-Y plane to make ultraviolet light pass therethrough and holds the mold 7 at the surrounding region for holding the mold chuck. At this time, the deformation mechanism imparts a positive pressure to the region of the mold 7 facing to the hollow bore to thereby be able to deform the mold 7 as described above. The main operations such as the contacting operation or the releasing operation performed by the imprint apparatus 1 may be realized by moving the mold 7 in the Z axial direction, may be realized by moving the wafer stage 4 (the wafer 12) in the Z axial direction, or may also be realized by moving both the mold 7 and the wafer stage 4 (the wafer 12) in the Z axial direction.

The wafer stage (substrate holding unit) 4 holds the wafer 12 by, for example, vacuum attraction. In particular, in the present embodiment, the wafer stage (substrate holding unit) 4 is movable (drivable) using a stage motor (second drive unit) which can generate a thrust and torque in the directions of six axes in total (X-, Y-, Z-, θx-, θy-, and θz-axes). Here, the wafer 12 is an object to be treated consisting of, for example, a single crystal silicon, and an ultraviolet curable resin (hereinafter referred to simply as “resin”), which is molded by the mold 7, is applied to the treatment surface thereof.

The dispenser 5 applies a resin (uncured resin) to the wafer 12. The dispenser 5 can apply a resin to a rectangular shot area on the wafer 12 by spraying liquid resin droplets linearly toward the surface of the wafer 12 using, for example, a droplet ejection method while the wafer 12 is being scan-driven by the wafer stage 4. Here, the resin is a photocurable resin having the property of being cured by receiving irradiation of ultraviolet light, and is appropriately selected depending on the types of semiconductor devices or the like.

The controller 6 may control the operation, adjustment, and the like of the components of the imprint apparatus 1. The controller 6 is constituted by a computer or the like and is connected to the components of the imprint apparatus 1 through a line so as to execute control of the components in accordance with a program or the like. In particular, in the present embodiment, the controller 6 executes at least calculation processing for calculating a command value to be output to the mold drive mechanism 14 included in the mold holding mechanism 3 and the stage motor included in the wafer stage 4, output processing for outputting the command value to a motor driver, and the like. Note that the controller 6 may be integrated with the rest of the imprint apparatus 1, or may be installed at a location separate from the location where the rest of the imprint apparatus 1 is installed.

Furthermore, the imprint apparatus 1 includes a stage surface plate (second surface plate) 15 that is installed on the floor and a measurement surface plate (first surface plate) 16 that is supported by the stage surface plate 15. The wafer stage 4 is installed on the upper surface of the stage surface plate 15. Furthermore, the stage surface plate 15 includes a plurality of leg portions 17 which extends upward in the Z axial direction. The leg portion 17 supports the measurement surface plate 16 via a vibration isolation mechanism 18 which is installed at an upper end of the leg portion 17 in the Z axial direction so as to suppress vibration from the floor. As the vibration isolation mechanism 18, an air spring used for a semiconductor exposure apparatus or the like may be employed serving as an active vibration isolating function. Here, it is preferable that spacing between the upper end of the leg portion 17 and the measurement surface plate 16 is kept constant. Hence, a XYZ-relative position measurement sensor (not shown) and a XYZ-direction driving linear motor (not shown) may be attached to upper and lower members of the air spring, i.e., the vibration isolation mechanism 18 and a servo valve for controlling air volume (not shown) may further be provided within the air spring. On the other hand, the measurement surface plate 16 holds the mold holding mechanism 3 and secures the dispenser 5 via a holder 19. Furthermore, the measurement surface plate 16 holds a head position sensor 20, a stage position sensor 21, a positioning microscope 22, and a gas supply nozzle 23.

The head position sensor 20 is a first measuring device that measures the translational moving amount of the imprint head 13 (mold chuck) in the Z-direction and the amount of rotation of the imprint head 13 (mold chuck) around θx- and θy-axes based on the installation position of the measurement surface plate 16. It is preferable that the head position sensor 20 is constituted by at least three or more sensors. While it is assumed that the head position sensor 20 is an encoder in the present embodiment, the head position sensor 20 may also be an interferometer or a capacitance sensor. In this case, the controller 6 takes the measurement value of the head position sensor 20, executes computation such that the mold chuck can follow the position target values and the thrust/torque target values in the Z-, θx-, and θy-directions, and generates a drive command value to be output to the mold drive mechanism 14 to thereby output the drive command value to the motor driver. The stage position sensor 21 is a second measuring device that measures the position of the wafer stage 4 in the directions of six axes in total (X-, Y-, Z-, θx-, θy-, and θz-axes). While it is assumed that the stage position sensor 21 is an interferometer in the present embodiment, the stage position sensor 21 may also be an encoder or the like. In this case, the controller 6 takes the measurement value of the stage position sensor 21, executes computation such that the wafer stage 4 can follow the position target values and the thrust/torque target values in the directions of six axes, and generates a drive command value to be output to the stage motor to thereby output the drive command value to the motor driver. Furthermore, the measurement surface plate 16 holds an interferometer 24 that measures the position of the imprint head 13 in the directions of X-, Y-, and θz-axes in addition to the sensors 20 and 21. In this case, the controller 6 takes the measurement value of the interferometer 24 and refers to the measurement value when the position of the wafer stage 4 is corrected. In this manner, the wafer stage 4 follows positional displacement of the imprint head 13 in the X and Y directions, which is caused by deformation due to force and heat, when the mold 7 is pressed against or released from the resin on the wafer 12, and thus, high alignment accuracy can be ensured.

The positioning microscope (off-axis alignment scope: OAS) 22 measures the position of the positioning mark formed on the wafer 12 or the wafer stage 4. More specifically, the positioning microscope 22 measures the global alignment of the wafer 12 and refers to the global alignment when the position of the wafer stage 4 is corrected during imprint processing, and thus, alignment accuracy is ensured.

The gas supply nozzle 23 supplies gas to the gap between the mold 7 and the wafer 12 when the mold 7 is pressed against the resin on the wafer 12. In general, if air bubbles remain in the space between the pattern formed on the mold 7 and the resin on the wafer 12 upon contacting, a pattern to be formed on the resin may be deflected, resulting in possible occurrence of defects. Hence, a gas supply device (not shown) supplies an inert gas such as helium having high solubility via the gas supply nozzle 23 to thereby suppress the occurrence of air bubbles. The gas supply nozzle 23 is held by the measurement surface plate 16 such that the discharge port provided at the bottom surface of the gas supply nozzle 23 is located in advance as close as possible to the position at which the wafer 12 is assumed to be placed upon contacting. On the other hand, gas to be supplied needs to be efficiently filled beneath the surface of the pattern formed on the mold 7, and thus, it is preferable that the mold 7 is spaced away from the wafer 12 as far as possible during the supply of gas. In contrast, the gas supply nozzle 23 of the present embodiment is held by the measurement surface plate 16, and thus, the present embodiment may handle such matters by appropriately adjusting the Z position of the imprint head 13.

Next, a description will be given of imprint processing performed by the imprint apparatus 1. Firstly, the controller 6 conveys the wafer 12 to the wafer stage 4 using a substrate conveyance unit (not shown) and performs alignment measurement to be described in detail below after the wafer 12 is placed on and fixed to the wafer stage 4. As the alignment measurement of the present embodiment, an advanced global alignment method (hereinafter referred to as “AGA”) is employed. Next, the controller 6 moves the wafer stage 4 to the application position of the dispenser 5. Then, as an application step, the dispenser 5 applies a resin (uncured resin) to a predetermined shot area (imprint area) on the wafer 12. Next, the controller 6 moves the wafer stage 4 such that the shot on the wafer 12 is placed in a position directly below the mold 7. Next, after the mold 7 is aligned with the shot on the wafer 12 and the magnification correction for the mold 7 is carried out using a magnification correction mechanism (not shown), the controller 6 drives the mold drive mechanism 14 so as to press the mold 7 against the resin on the wafer 12 (contacting step). At this time, the resin is filled in the concave portion of the pattern formed in the mold 7 during the contacting step. Under this condition, the light irradiation unit 2 emits the ultraviolet light 8 from the back surface (top surface) of the mold 7, and the resin is cured by the ultraviolet light 8 that has been transmitted through the mold 7. After the resin is cured, the controller 6 again drives the mold drive mechanism 14 to thereby release the mold 7 from the resin on the wafer 12 (releasing step).

In particular, since the measurement surface plate 16 of the present embodiment is supported by the leg portion 17 via the vibration isolation mechanism 18, the measurement surface plate 16 is separated from the structural deformation of the lower part of the leg portion 17. The structural deformation is caused, for example, by a moving load generated when the wafer stage 4 is driven in the X and Y directions. In contrast, since the measurement surface plate 16 is separated from the structural deformation and the deformation of the measurement surface plate 16 itself is suppressed by the vibration isolation mechanism 18, there is no change in the reference positions of position sensors 20 and 21 and the positional displacement correcting interferometer 24 provided in the measurement surface plate 16. Thus, the controller 6 can performs accurate positioning based on alignment information as it is from the measurement result obtained by the alignment measurement employing AGA.

Here, in the contacting step, a pressing force (contacting force) directed upward along the Z axis is applied to the mold 7, whereas a pressing force directed downward along the Z axis is applied to the wafer 12. The pressing force may cause variation of the film thickness of the resin on the wafer 12 or an increase in variation thereof by varying the orientation of the mold 7 or the wafer 12 or the Z position thereof. In particular, it is preferable that the film thickness of the resin is as thin as possible without variation in the film thickness. Thus, the orientation of the mold 7 and the wafer 12, that is, the orientation of the imprint head 13 (mold chuck) and the wafer stage 4 for holding the mold 7 and the wafer 12, respectively, needs to be held so as not to be changed even by receiving a pressing force. Accordingly, in the present embodiment, the controller 6 adds a position servo control loop in the pressing force take-up direction and controls the imprint head 13 and the wafer stage 4 so as to be held in the same orientation by immediately generating a force opposite the pressing force.

On the other hand, in the releasing step, a releasing force (releasing force) directed downward along the Z axis is applied to the mold 7, whereas a releasing force directed upward along the Z axis is applied to the wafer 12. The releasing force is typically very large from tens to a hundred and several tens of N. Thus, if the releasing force is applied to the imprint head 13 and the wafer stage 4, the releasing force may cause variations in the orientation of both the imprint head 13 and the wafer stage 4 or structural vibration. This means that the pattern formed (transferred) on the resin may be fallen down at the moment of releasing due to the uneven pattern formed on the mold 7 if the relative position between the mold 7 and the wafer 12 is displaced in the X and Y directions. In general, in the imprint apparatus, the line width of a circuit pattern is targeted to be in the range of about 10 to about 30 nm. Thus, if the relative positional displacement between the mold 7 and the wafer 12 occurs in the X and Y directions at the same level as the line width, the pattern is readily broken. Accordingly, in the present embodiment, a control method for reducing the shake of both the position servo control loop for the wafer stage 4 in the X and Y directions and the position servo control loop for the imprint head 13 in the θx and θy directions is added to the controller 6. Examples of such control method include as follows. The first control method is to feed-forward a releasing force derived from an actuator current or the like applied to both drive systems of the wafer stage 4 and the imprint head 13 and to estimate disturbances (force) applied to the servo loop so as to cancel the disturbances (force). The second control method is to increase the control gain and enhance the servo rigidity of both the wafer stage 4 and the imprint head 13 so as to reduce the shake thereof. The third control method (negative compliance control) is to estimate disturbances to be applied in the X and Y directions upon releasing based on the actuator current applied to the drive system of the wafer stage 4 and to change the position of the wafer stage 4 so as to make disturbances lower than a predetermined level.

In a typical imprint apparatus, the mold 7 and the wafer 12 are sufficiently solid members and the position control systems thereof interfere with each other when the mold 7 is in contact with the wafer 12. Thus, since two position servo control systems relating to the mold drive mechanism 14 and the stage motor are prevented from being freely positioned particularly in the Z-, θx-, and θy-directions, there is a high probability that servo resonance occurs such that both position servo control systems are in the oscillation state. On the other hand, it is preferable that the servo control band of each of two position servo control systems is as high as possible. The reason for this is to withstand disturbances during the contacting and releasing steps and to achieve high throughput as well as imprint accuracy by reducing the imprint time as much as possible and performing imprint processing accurately within the time limit. However, two servo resonance points become closer to each other at a high frequency band. Consequently, servo resonance readily occurs at the frequency. Therefore, in the present embodiment, the configuration for suppressing servo resonance during the contacting and releasing steps is provided for two position servo control systems by taking these possibilities into consideration.

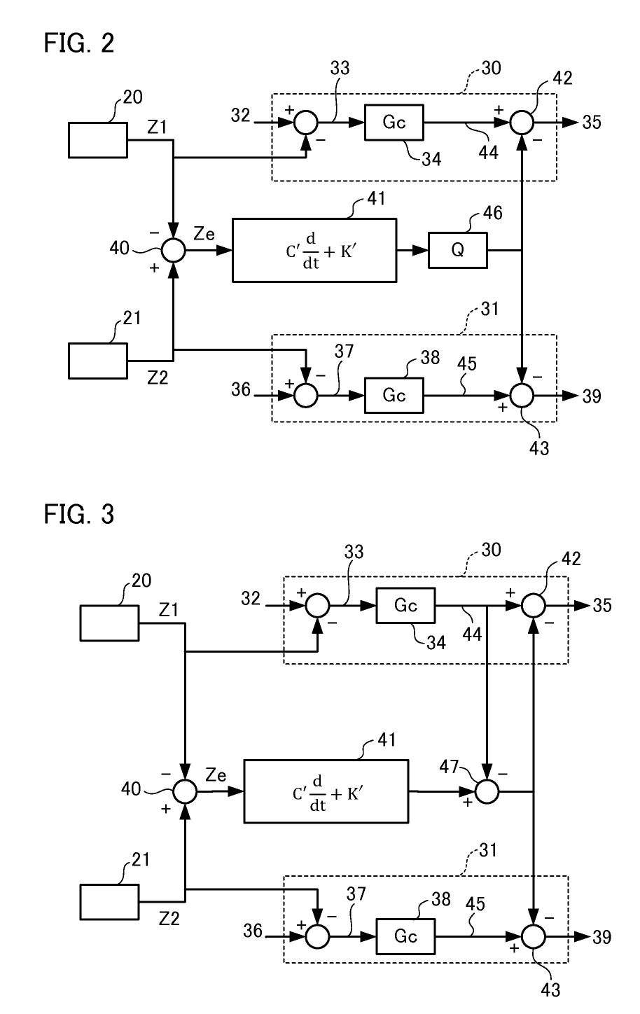

Hereinafter, a description will be given of a Z-direction stabilization control system for suppressing the servo resonance of the present embodiment during the contacting and releasing steps. FIG. 2 is a block diagram illustrating a stabilization control system including a first position control loop (first servo controller) 30 provided in the imprint head 13 (mold chuck) side and a second position control loop (second servo controller) 31 provided in the wafer stage 4 side. Firstly, in the first position control loop 30, the controller 6 calculates a difference 33 between a Z position (positional information) Z1 which is state information about the imprint head 13 acquired by the head position sensor 20 and a position target value (target value) 32 of the imprint head 13. Next, the controller 6 generates a command value 35 for the motor driver of the mold drive mechanism 14 at a control calculation block (transfer function G_{c}) 34 based on the difference 33. Likewise, in the second position control loop 31, the controller 6 calculates a difference 37 between a Z position Z2 which is state information about the wafer stage 4 acquired by the stage position sensor 21 and the position target value 36 of the wafer stage 4. Next, the controller 6 generates a command value 39 for the motor driver of the stage motor at a control calculation block (transfer function G_{c}) 38 based on the difference 37.

Here, it is highly probable that servo resonance as described above is caused by the spring force exerted by the portion where the mold 7 is in contact with the resin on the wafer 12 during contacting and releasing. In particular, servo resonance is readily affected by the spring characteristics of the mold 7 made of quartz. Accordingly, in the stabilization control system of the present embodiment, the force acting between the mold 7 and the wafer 12 is derived from the measurement values obtained by the head position sensor 20 and the stage position sensor 21, and is reflected on the command values 35 and 39 for the respective motor drivers. The force can be derived by using the fact that the controller 6 derives a positional difference between the mold 7 and the wafer 12 and calculates how much displacement has occurred in the spring force exerted by the portion where the mold 7 is in contact with the resin on the wafer 12.

In this case, firstly, the controller 6 calculates a difference Ze between the Z position Z1 of the imprint head 13 and the Z position Z2 of the wafer stage 4 at a summing point 40. Next, the controller 6 sums the product (K′) of the difference Ze and the estimated spring constant P of the mold 7 in the Z axial direction and the product (C′(d/dt)) of the first-order derivative (time derivative) of the difference Ze and the estimated viscosity coefficient C of the mold 7 in the Z axial direction at a stabilization control block (correction controller) 41. Here, the estimated spring constant P corresponds to a proportional gain and the estimated viscosity coefficient C corresponds to a differential gain. The value derived at the stabilization control block 41 is equivalent to the force of pushing or pulling the mold 7 in the Z axial direction by means of the imprint head 13 and the wafer stage 4. Next, the controller 6 subtracts the value derived at the stabilization control block 41 from the outputs 44 and 45 from the control calculation blocks 34 and 38, respectively, at summing points 42 and 43 to thereby cancel forces exciting the imprint head 13 and the wafer stage 4, which are applied to the mold 7, at the position control loops 30 and 31.

Here, in the stabilization control system, the occurrence of an error in the estimated spring constant P to some extent is not preferred because the error may lead to oscillation. In addition, the upper limit and the lower limit of error tolerance in the estimated spring constant P, which may lead to oscillation, may often vary depending on the state of the imprint head 13 and the wafer stage 4 during the contacting and releasing steps. Accordingly, in the stabilization control system of the present embodiment, the estimated spring constant P is set near the middle of the error tolerance range in order to improve its robustness.

In this case, when the true spring constant (rigidity) of the mold 7 directed toward a direction in contact with the resin on the wafer 12 is designated as “K” and variables “α” and “β” are given, the estimated spring constant P is represented by the following Formula (1):

P=α(K+β) (1)

There are three conditions which may cause variations in error tolerance of the estimated spring constant P. The first condition relates to the distance between the imprint position (contact position) and the moment center of the wafer stage 4 in the θx- and θy-directions. When the first condition is considered in Formula (1), it is preferable that the value of the variable α is not less than 0.85 but less than 1.15 and the value of the variable β is a value less than 70% of the true spring constant K and is changed in accordance with the imprint position in the X and Y directions. The second condition relates to a resin filling rate within the area of the pattern formed on the mold 7. In other words, the values of the variables α and β may be changed based on the filling rate. The filling rate can be derived by the fact that the controller 6 acquires the relationship between the progression (state) of filling a resin and time in advance using a photographing device (state measuring device) 11 and changes the values of the variables α and β so as to maintain the relationship. The filling rate can also be derived by the fact that the controller 6 performs real-time area measurement of a region to be filled with a resin using the photographing device 11 and feed backs the measurement result to the settings of the variables α and β. Furthermore, the third condition relates to a command value or a measurement value for a deformation force to be applied to the mold 7 to change the shape of the mold 7 into a convex shape. A change in the shape of the mold 7 may affect the filling rate. Thus, the controller 6 may also change the values of the variables α and β based on the command value or the measurement value of the deformation force.

It is preferable that the output derived at the stabilization control block 41 is passed through a filter (Q) 46. As the filter 46, a band-pass filter or the like that identifies in advance a specific frequency band at which servo resonance readily occurs to thereby attenuate the frequency band other than the vicinity of the specific frequency band may be employed. On the other hand, a stabilization control system may also have another configuration as shown in FIG. 3 excluding the filter. In the stabilization control system, when the imprint head 13 performs a pressing operation in the Z axial direction, the output 44 of the control calculation block 34 becomes a pressing force command value. Thus, the controller 6 subtracts the output 44 of the control calculation block 34 from the output of the stabilization control block 41 at a summing point 47. In this manner, only a feed-forward amount for canceling only a disturbance factor which is caused by the spring component of the mold 7 except for the force component required during contacting and releasing can be derived.

While a description has been given of the stabilization control system only in the Z axial direction during the contacting and releasing steps, a similar control system may be employed for other directions, in particular, the θx and θy directions.

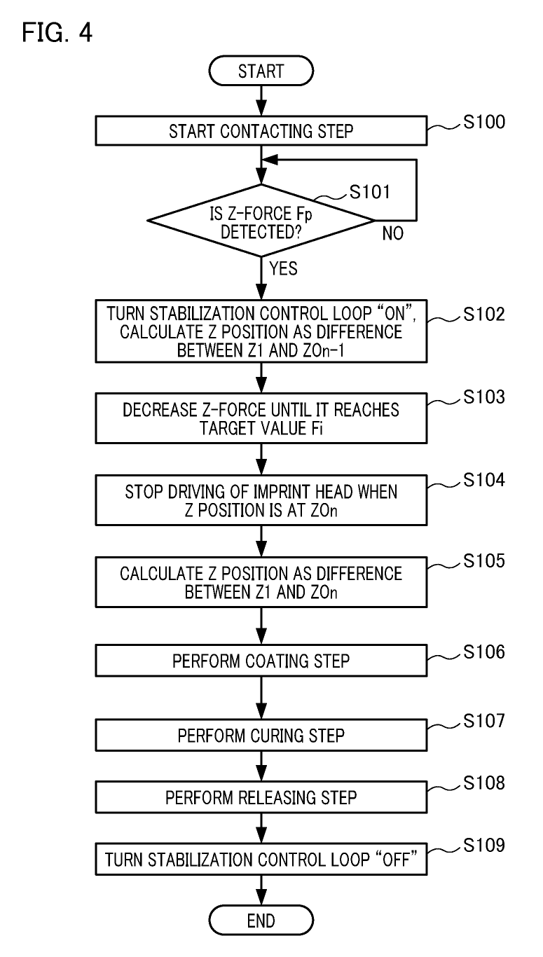

Next, a description will be given of the timing at which a loop is effective by the stabilization control system in the imprint processing steps performed by the imprint apparatus 1. FIG. 4 is a flowchart illustrating the flow of the imprint processing steps including a stabilization control loop. When the imprint processing steps are started, the controller 6 first drives the imprint head 13 in the Z axial direction toward the wafer 12 as a contacting step (step S100). Next, the controller 6 monitors a drive current applied to the mold drive mechanism 14 when the mold 7 is brought into contact with the resin on the wafer 12 and stops supplying the drive current when the Z-force becomes equal to or greater than a predetermined value (step S101).

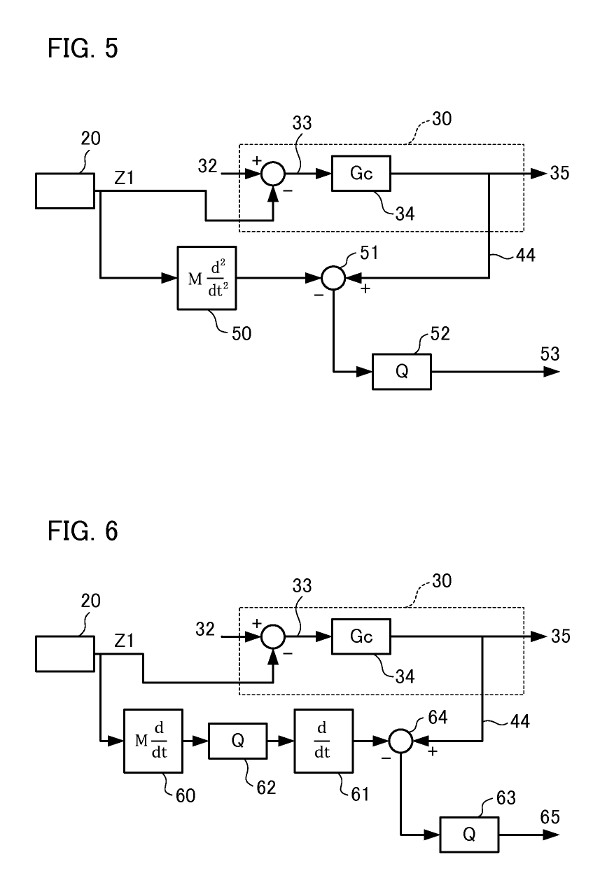

Here, the “Z-force” refers to the Z-axis directional force (state amount) to be applied to the wafer 12 by the imprint head 13 via a resin. The Z-force is calculated based on the control state amount such as motor current, acceleration, or the like of the stage motor provided in each of the mold drive mechanism 14 and the wafer stage 4. Hereinafter, a description will be given of a method for deriving the Z-force. FIG. 5 and FIG. 6 are block diagrams illustrating the first and the second examples of a control system for deriving a Z-force based on the control amount of the imprint head 13. In FIG. 5 and FIG. 6, the same elements as those in the stabilization control system shown in FIG. 2 are designated by the same reference numerals, and explanation thereof will be omitted. In the control system shown in FIG. 5, the controller 6 first performs quadratic differential to the Z position Z1 of the imprint head 13, which has been acquired by the head position sensor 20, using a differentiator 50 and multiplies a moveable mass M to the resulting quadratic differential value to thereby derive the acceleration force (deceleration force) of the imprint head 13. Next, the controller 6 subtracts the acceleration/deceleration force of the imprint head 13 from the output 44 of the control calculation block 34 at a summing point 51 to thereby derive the reaction force for a pressing force applied to the wafer 12 by the imprint head 13 via a resin. Furthermore, since it is highly probable that the output of the differentiator 50 contains considerable noise, the controller 6 removes the noise from the output of the summing point 51 via a filter 52 and uses an output 53 from which the noise has been removed as a Z-force for the following control. On the other hand, the control system shown in FIG. 6 has two differentiators 60 and 61 formed by splitting the differentiator 50 and filters 62 and 63 disposed at the subsequent stage to the differentiators 60 and 61, respectively. In this case, the controller 6 first subtracts the acceleration deceleration force of the imprint head 13, which is the output of a differentiator 61, from the output 44 of the control calculation block 34 at a summing point 64. Then, the controller 6 removes the noise from the output of the summing point 64 via a filter 63 and uses an output 65 from which the noise has been removed as a Z-force for the following control. According to the second example, the Z-force from which the noise has been removed greater than that in the first example may be obtained. In the method for deriving a Z-force, the Z-force is derived based on the control amount of the imprint head 13 but may also be similarly derivable from the control amount of the wafer stage 4.

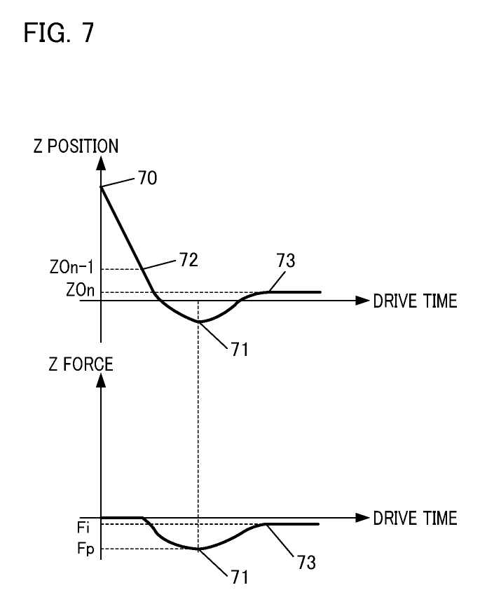

FIG. 7 is a graph illustrating the Z position with respect to the drive time of the imprint head 13 in step S101 and the Z-force generated between the mold 7 corresponding to the Z position and the resin on the wafer 12. When the imprint head 13 starts driving toward the wafer 12, the curve of the Z position gradually decreases from a point 70 and stops decreasing when the curve reaches at a point 71 (a point at which the Z-force becomes a desired amount Fp) as shown in FIG. 7. In the graph indicating the Z-force, the negative sign of the Z-force in the graph shown in FIG. 7 indicates the fact that the Z-force acts in a direction in which the mold 7 is pressed against the wafer 12 (resin) by the imprint head 13. In the graph indicating the Z position, a point 72 indicates the stabilized Z position (=ZOn−1) in the previous imprint processing steps, and the previous curing step and releasing step were performed at the Z position.

Referring back to FIG. 4, next, the controller 6 detects a constant Z-force Fp in step S101 (YES). Then, the controller 6 stops the driving of the imprint head 13 and at the same time turns the stabilization control loop of the stabilization control system “ON” (step S102). Here, positional information Z1 about the imprint head 13 is a difference value between the Z position Z1 of the imprint head 13 by the head position sensor 20 and the stabilized Z position (ZOn−1). In other words, the amount of pressing the mold 7 further against the wafer 12 from the stabilized Z position as a reference position is calculated. For example, the controller 6 may also stop the driving of the imprint head 13 when the Z positional difference Ze (relative position) between the imprint head 13 and the wafer stage 4 as shown in FIG. 2 becomes a predetermined amount, i.e., ZOn−1, and turn the stabilization control loop “ON”.

Next, the controller 6 decreases the Z-force and moves the imprint head 13 in the releasing direction until the Z-force reaches the target value Fi of the pre-derived force which is capable of stably performing the subsequent contacting and releasing steps (step S103). The step 103 corresponds to the curve extending from the point 71 to a point 73 shown in FIG. 7. The target value Fi and the Z position (ZOn) at the point 73 which is the target value Fi are referred to in the following steps. It should be noted that the usefulness of the present embodiment is still ensured even when a step of varying the value of the Z position ZOn by varying the height of the convex shape of the mold 7 is included after step S103. Although the controller 6 varies the Z-force with the stabilization control loop set valid (ON), this does not affect the feed-forward amount calculated in the stabilization control system. The reason is as follows. In the present embodiment, in the stabilization control system shown in FIG. 2, the follow-up of the command value for the force is cut out by the filter 46, whereas in the stabilization control system shown in FIG. 3, only the component of the spring characteristics of the mold 7 is extracted so as to subtract the command value for the force.

Next, the controller 6 stops the driving of the imprint head 13 after the Z-force reaches the target value Fi (after the Z position reaches ZOn) (step S104). Next, the controller 6 changes in calculation of the positional information Z1 about the imprint head 13 as a difference value between the Z position Z1 of the imprint head 13 by the head position sensor 20 and the Z position ZOn (step S105). Next, the controller 6 stands by until the concave portion of the pattern formed on the mold 7 is filled with the resin. Then, the controller 6 shifts from a coating step (step S106) to a curing step (step S107), executes a releasing step (step S108) after the resin on the wafer 12 is cured, and turns the stabilization control loop “OFF” (step S109). Then, a series of steps is ended.

As described above, according to the present embodiment, an imprint apparatus that is capable of accurately holding the contact position at which the mold 7 is in contact with the resin on the wafer 12 and is advantageous for improving positioning accuracy during alignment measurement employing AGA may be provided.

While, in the embodiment, a description has been given of the servo control of the mold drive mechanism 14 in three axis directions (Z axis direction, θx axis direction, and θy axis direction) and the position/force control thereof, the present invention is not limited thereto. The present invention is still effective even when another servo control such as position servo control in the X and Y directions other than three axis directions, speed control, or the like is added to the stabilization control system.

Although, in the embodiment, the imprint apparatus 1 is intended to include one mold holding mechanism and one wafer stage, the present invention is not limited thereto. For example, in the imprint apparatus of the present invention, two mold holding mechanisms, two dispensers, two wafer stages, and the like may also be provided on one measurement surface plate or one stage surface plate. Furthermore, in the imprint apparatus of the present invention, two wafer stages may also be provided with respect to one mold holding mechanism and one dispenser. In this case, the controller first performs imprint processing for a wafer placed on one wafer stage and performs AGA for another wafer placed on the other wafer stage during imprint processing. After processing for two wafers, their treating positions are switched. Next, the controller collects one wafer subjected to imprint processing and places a new wafer on the wafer stage to thereby perform AGA. For the other wafer subjected to AGA on the wafer stage, the controller performs imprint processing based on the measurement result.

### (Article Manufacturing Method)

A method for manufacturing a device (semiconductor integrated circuit element, liquid display element, or the like) as an article may include a step of forming a pattern on a substrate (wafer, glass plate, film-like substrate, or the like) using the imprint apparatus described above. Furthermore, the manufacturing method may include a step of etching the substrate on which a pattern has been formed. When other article such as a patterned medium (storage medium), an optical element, or the like is manufactured, the manufacturing method may include other step of processing the substrate on which a pattern has been formed instead of the etching step. The article manufacturing method of the present embodiment has an advantage, as compared with a conventional article manufacturing method, in at least one of performance, quality, productivity and production cost of an article.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-153737 filed Jul. 12, 2011 which is hereby incorporated by reference herein in its entirety.

What is claimed is:

1. An imprint apparatus that brings an imprint material on a substrate into contact with a mold to thereby transfer a pattern formed on the mold onto the substrate, the imprint apparatus comprising:
a mold holding unit configured to hold the mold;
a substrate holding unit configured to hold the substrate;
first and second drive units configured to drive the mold holding unit and the substrate holding unit, respectively, in a contact direction;
first and second position sensors configured to detect the positions of the mold holding unit and the substrate holding unit, respectively, in the contact direction; and
a controller configured to control the first and second drive units,
wherein the controller comprises:
a first servo controller configured to servo-control the first drive unit based on the position detected by the first position sensor and a first target value;
a second servo controller configured to servo-control the second drive unit based on the position detected by the second position sensor and a second target value; and
a correction controller configured to execute calculation processing for calculating a correction value for correcting a force, which is applied to the mold or the substrate when the mold is brought into contact with the substrate via the imprint material, based on the relative position between the mold holding unit and the substrate holding unit in the contact direction and correct at least one of command values to be transmitted to the first or second drive unit by the first or second servo controller based on the correction value.

2. The imprint apparatus according to claim 1, wherein the first and second drive units are drivable in a tilt direction, the positions detected by the first and second position sensors include the tilt direction, and the relative position includes the relative position in the tilt direction.

3. The imprint apparatus according to claim 1, wherein the controller starts the calculation processing in accordance with the relative position between the mold holding unit and the substrate holding unit.

4. The imprint apparatus according to claim 1, wherein the controller starts the calculation processing in accordance with a state amount relating to a force imparted from one to the other when the mold is brought into contact with the substrate via the imprint material.

5. The imprint apparatus according to claim 1, wherein the controller sums the product of the relative position and a predetermined proportional gain and the product of a differential value of the relative position and a predetermined differential gain to thereby calculate the correction value.

6. The imprint apparatus according to claim 5, wherein, when the proportional gain is designated as “P”, the rigidity of the mold in the contact direction is designated as “K”, and variables “α” and “β” are given, the proportional gain is represented by the following formula:
P=α(K+β).

7. The imprint apparatus according to claim 6, wherein the variable α is not less than 0.85 but less than 1.15 and the variable β is a value less than 70% of the rigidity.

8. The imprint apparatus according to claim 6, wherein the controller changes the values of the variable α and the variable β in accordance with the relative position between the mold and the substrate holding unit in a direction orthogonal to the contact direction.

9. The imprint apparatus according to claim 6, further comprising:
a detector configured to detect the state of filling of the imprint material into a pattern formed on the mold when the mold is brought into contact with the imprint material,
wherein the controller changes the values of the variable α and the variable β in accordance with the output of the detector.

10. The imprint apparatus according to claim 6, further comprising:
a deformation mechanism configured to deform the mold into a convex shape toward the contact direction,
wherein the controller changes the values of the variable α and the variable β in accordance with a force applied to the mold by the deformation mechanism.

11. The imprint apparatus according to claim 1, further comprising:
a first surface plate on which the mold holding unit is installed; and
a second surface plate on which the substrate holding unit is installed,
wherein the first surface plate is supported by a leg portion installed on the second surface plate via a vibration isolation mechanism.

12. The imprint apparatus according to claim 11, wherein the first and second position sensors are installed on the first surface plate.

13. The imprint apparatus according to claim 1, wherein the calculation processing comprises filter processing for attenuating a specific frequency band.

14. An article manufacturing method comprising:
bringing an imprint material on a substrate into contact with a mold using an imprint apparatus to thereby transfer a pattern formed on the mold onto the substrate; and
processing the substrate on which the pattern has been formed in the forming step,
wherein the imprint apparatus comprises:
a mold holding unit configured to hold the mold;
a substrate holding unit configured to hold the substrate;
first and second drive units configured to drive the mold holding unit and the substrate holding unit, respectively, in a contact direction;
first and second position sensors configured to detect the positions of the mold holding unit and the substrate holding unit, respectively, in the contact direction; and
a controller configured to control the first and second drive units,
wherein the controller comprises:
a first servo controller configured to servo-control the first drive unit based on the position detected by the first position sensor and a first target value;
a second servo controller configured to servo-control the second drive unit based on the position detected by the second position sensor and a second target value; and
a correction controller configured to execute calculation processing for calculating a correction value for correcting a force, which is applied to the mold or the substrate when the mold is brought into contact with the substrate via the imprint material, based on the relative position between the mold holding unit and the substrate holding unit in the contact direction and correct at least one of command values to be transmitted to the first or second drive unit by the first or second servo controller based on the correction value.
